(19) United States
(12) Patent Application Publication
(10) Pub. No.: US 2007/0140351 A1
(43) Pub. Date: Jun. 21, 2007

(54) INTERPOLATION UNIT FOR PERFORMING HALF PIXEL MOTION ESTIMATION AND METHOD THEREOF

(76) Inventor: Hsieh-Chang Ho, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/306,058

(22) Filed: Dec. 15, 2005

(51) Int. Cl. H04N 11/04; H04N 7/12

(52) U.S. Cl. 375/240.24; 375/240.26

(57) ABSTRACT

An interpolative prediction unit is coupled to a plurality of N columns of a reference picture and to a plurality of M columns of an inverse discrete cosine transform residual signal, the interpolative prediction unit for generating pixel data corresponding to a macroblock in motion estimation and compensation, and includes an interpolation unit being coupled to a first column and an adjacent second column of the N columns of the reference picture for outputting an interpolated pixel value according to pixel values of the first column and the adjacent second column; and an adder being coupled to the interpolation unit and a first column of the inverse discrete cosine transform residual signal for adding the interpolated pixel value outputted by the interpolation module and the first column of the inverse discrete cosine transform residual signal to thereby generate video data corresponding to a first column of the macroblock.

### BACKGROUND OF THE INVENTION

1. Field of the Invention

The invention relates to motion compensation and estimation for digital video, and more particularly, to performing half pixel interpolation during motion compensation and estimation.

2. Description of the Prior Art

Moving Picture Experts Group (MPEG) is the name of a family of standards used for coding audio-visual information (e.g., movies, video, music) in a digital compressed format. Within the MPEG standards, full motion video image compression is defined both between frames (i.e., interframe compression or temporal compression) and within a given frame (i.e., intraframe compression or spatial compression). lnterframe compression is accomplished via a motion compensation (motion compensation) process. Intraframe compression is accomplished by conversion of the digital image from the time domain to the frequency domain using, among other processes, discrete cosine transform (DCT). The major advantage of using MPEG compression techniques compared to other standards is that MPEG files retain enough information to preserve the quality of the original signal and are generally much smaller than files with a similar level of quality created by competing standards.

The MPEG-2 standard covers a wide range of applications, including interlaced digital video (e.g. HDTV). An interlaced digital video data stream (file) can be arranged in successive groups of pictures, each of which includes compressed data from a like number of image frames. Frames are comprised of top and bottom fields that are snapshots in time of a scene. There are three types of encoded/compressed frames, referred to as the intra (I) frame, the predicted (P) frame, and the bi-directional interpolated (B) frame. The I frames contain the video data for the entire frame of video and are typically placed every 12 to 15 frames. I frames provide entry points into the file for random access, and are generally only moderately compressed. P frames only include changes relative to prior I or P frames because P frames are encoded with reference to a prior I frame or P frame, and P frames receive a fairly high amount of compression. B frames include the greatest amount of compression and occur between I and P or P and P or I and I frames because they require both a past and a future reference in order to be decoded. B frames are never used as references for other frames. Thus, both I and P frames can be referred to as reference frames because they are used as references for future P and B frames.

An encoding process divides frames into a grid of 16 by 16 pixel squares called macroblocks. Because frames are comprised of top and bottom fields, macroblocks are comprised of the two fields as well, i.e., macroblocks can be either frame-based encoded (the fields are mixed together) or field-based encoded (the fields are grouped separately). In a typical application, chrominance information is subsampled. For example, in 4:2:0 format, a macroblock is actually comprised of 6 blocks, four of which convey luminance information and two of which convey chrominance information. Each of the four luminance blocks represent an 8 by 8 matrix of pixels or one quarter of the 16 by 16 matrix. Each of the chrominance blocks is an 8 by 8 matrix representing the entire 16 by 16 matrix of pixels. The respective blocks contain DCT coefficients generated from respective matrices of pixel data. One DCT coefficient conveys DC or average brightness information, and each of the remaining DCT coefficients convey information related to different image spatial frequency spectra. For instance, I frame DCT coefficients represent image data and P and B frame DCT coefficients represent frame difference data. The DCT coefficients are arranged in a particular order with the DCT coefficient conveying DC first and the remaining DCT coefficients in order of spectral importance. Each macroblock includes a header containing information about the particular picture piece as well as its placement in the next larger piece of the overall picture followed by motion vectors (motion vectors) and coded DCT coefficients. Much of the data, including DCT coefficients and header data, is variable length coded. In addition some of the data, such as the DCT coefficient conveying DC and motion vectors, are differential pulse code modulation (DCPM) coded.

The respective frames are divided into macroblocks by an encoding process in order for motion compensation based interpolation/prediction to subsequently be performed by a decoding system. Since frames are closely related, it is assumed that a current frame can be modeled as a translation of the frame at the previous time. Therefore, it is possible then to “predict” the data of one frame based on the data of a previous frame. In P frames, each macroblock is predicted from a macroblock of a previously encoded I or P frame (reference frame). However, the macroblocks in the two frames may not correspond to the same spatial location. In generating an motion compensation prediction from an immediately preceding I or P frame, motion vectors are generated which describe the displacement of the best match macroblocks of the previous I or P frame to the cosited macroblocks of the current P frame. A P frame is then created using the motion vectors and the video information from the prior I or P frame. The newly created P frame is then subtracted from the current frame and the differences (on a pixel basis) are termed residues. A typical single direction motion compensation process is shown in FIG. 1. Motion compensation based prediction and interpolation for B frames is similar to that of P frames except that for each B frame, motion vectors are generated relative to a successive I or P frame and a prior I or P frame. These motion vectors are analyzed for the best match and the P frame is generated from the motion vector indicated to more accurately predict an image area, or from a weighted average of predicted images using both the forward and backward motion vectors. A typical bidirectional motion compensation process is shown in FIG. 2.

In terms of circuitry of a decoding system arranged to decompress an interlaced digital video data stream, generally, the digital video data stream can be applied to a variable length decoder (VLD), wherein the VLD extracts data from the digital video data stream. The VLD is capable of performing variable length decoding, inverse run length decoding, and inverse DPCM coding as appropriate. Decoded DCT coefficients from the VLD can be applied to an inverse DCT (IDCT) circuit which includes circuitry to inverse quantize the respective DCT coefficients and to convert the coefficients to a matrix of pixel data. The pixel data can then be coupled to one input of an adder. Decoded motion vectors from the VLD can be applied to the motion compensation predictor, and in response to motion vectors, the motion compensation predictor can access corresponding blocks of pixels stored in a memory device and apply the same to a second input of the adder. The adder sums up the output of the IDCT and the motion compensation predictor to reconstruct the frame. Once reconstructed, there are two paths for the reconstructed frame: one path directly for output and one path to the memory device that is coupled to the motion compensation predictor.

Specifically, when I frames are being processed, the motion compensation predictor is conditioned to apply zero values to the adder. The IDCT processed data provided by the IDCT device corresponds to blocks of pixel values. These values are passed unaltered by the adder, and are outputted and stored in the memory device as a reference frame for use in predicting subsequent frames. Immediately after an I frame is decoded, a P frame corresponding to a frame occurring a predetermined number of frames after the I frame, is available from the VLD. This P frame was, at the encoder, predicted from the preceding I frame. The DCT coefficients of this P frame thus represent residues, which when added to the pixel values of the decoded I frame, will generate the pixel values for the current P frame. On decoding this P frame, the IDCT device provides decoded residue values to the adder, and the motion compensation predictor, responsive to the motion vectors, accesses the corresponding blocks of pixel values of the I reference frame from the memory device and applies them in appropriate order to the adder. The sums provided by the adder are the pixel values for this P frame. These pixel values are outputted and also stored in the memory device as a reference frame for use in predicting subsequent frames. Subsequent to the decoding of the P frame, B frames, which normally occur intermediate the I and P frames, are provided. B frames are decoded similarly to the P frame, but are only outputted and not stored in the memory device.

In some applications, a digital video data stream needs to be displayed at a smaller resolution than it has upon reception. For example, as high definition television (HDTV) is likely to become the digital TV broadcast standard in the U.S., there is a need for low cost decoding systems with High Definition (HD) capacity but Standard Definition (SD)-format output. In a standard MPEG-2 decoding system, for example, three frames of memory are needed for use in decoding the input stream, one for backward reference, one for forward reference, and a third one for the current frame. However, the frame memory size is matched to input resolution, i.e., if input is HD, 3 frames of HD size memory are required to decode the input stream.

An external scaler could be added to such a standard MPEG-2 decoding system to reduce the output resolution. However, the cost for such a system is HD resolution frame memory, HD resolution decoding complexity, and spatial (pixel) domain filtering for down scaling. Alternatively, by downscaling the reference frame just before storage in such a standard MPEG-2 decoding system, memory can be saved by matching memory requirement to the output resolution (SD resolution frame memory can be provided). However, there is no saving regarding computation complexity in this approach, since the decoding loop is still working at full (input) resolution. Furthermore, upscaling would have to be added before motion compensation (motion compensation), which further increases the computation complexity. The downscaling can be moved further forward in the decoding path so that the motion compensation can work in the reduced resolution as well, i.e., no upscaling is needed. Motion vectors, in this case, are needed to be scaled down for the reduced resolution motion compensation. As the motion vectors are scaled down, their precision increase. For a downscaling factor of 2, for example, the motion vectors after scaling are half in magnitude but twice in precision (from ½ pel to ¼ pel). This increase in motion vector precision results in more cases where interpolation is required (i.e., when the motion vector is non-integer). Concerning the interpolation operations, FIG. 3 shows typical equations for the various half pixel interpolation positions encountered in MPEG-2.

FIG. 4 shows a first typical interpolative prediction unit according to the related art. As shown in FIG. 4, the interpolative prediction unit includes an interpolation unit 402, a storage unit 404, and an adder unit 406. In a first phase of operation, a past frame is received at the interpolation unit 402, and the interpolation unit 402 performs half pixel interpolation to determine pixel values corresponding to whole pixel values of the past frame. These pixel values corresponding to whole pixel values of the past frame are then stored in the storage unit 404. Next, in a second phase of operation, a future frame is received at the interpolation unit 402, and the interpolation unit 402 performs half pixel interpolation to determine pixel values corresponding to whole pixel values of the future frame. Finally, the pixel values corresponding to whole pixel values of the future frame outputted by the interpolation unit 402 are added to the pixel values corresponding to whole pixel values of the past frame stored in the storage unit 404, and the result is divided by two to account for the addition of two frames. Then the results are added to idct residual signal. In this way, video data corresponding to a motion prediction operation is generated in two stages of operation.

FIG. 5 shows a second typical interpolative prediction unit 500 according to the related art. As shown in FIG. 5, the interpolative prediction unit 500 includes a first interpolation unit 502, a second interpolation unit 504, and an adder unit 506. A future frame is received at the first interpolation unit 502, and the first interpolation unit 502 performs half pixel interpolation to determine pixel values corresponding to whole pixel values of the future frame. Simultaneously, a past frame is received at the second interpolation unit 504, and the second interpolation unit 504 performs half pixel interpolation to determine pixel values corresponding to whole pixel values of the past frame. The pixel values corresponding to whole pixel values of the future frame outputted by the first interpolation unit 502 are added to the pixel values corresponding to whole pixel values of the past frame outputted by the second interpolation unit 504, and the result is divided by two to account for the addition of two frames. Then the results are added to idct residual signal. In this way, video data corresponding to a motion prediction operation is generated in a single stage of operations.

However, the above described interpolative prediction units 400, 500 require either costly hardware such as the storage device 404, or redundant interpolation hardware such as the second interpolation unit 504 when doing single direction motion compensation. An improved interpolative prediction unit architecture would be greatly beneficial.

### SUMMARY OF THE INVENTION

One objective of the claimed invention is therefore to provide a interpolative prediction unit for generating pixel data corresponding to a macroblock in motion estimation and compensation, to solve the above-mentioned problems.

According to an exemplary embodiment of the claimed invention, a single direction systolic array architecture interpolative prediction unit being coupled to a plurality of N columns of a reference picture and to a plurality of M columns of an inverse discrete cosine transform residual signal is disclosed. The interpolative prediction unit is for generating pixel data corresponding to a macroblock in motion estimation and compensation, and comprises an interpolation unit being coupled to a first column and an adjacent second column of the N columns of the reference picture for outputting an interpolated pixel value according to pixel values of the first column and the adjacent second column; and an adder being coupled to the interpolation unit and a first column of the inverse discrete cosine transform residual signal for adding the interpolated pixel value outputted by the interpolation module and the first column of the inverse discrete cosine transform residual signal to thereby generate video data corresponding to a first column of the macroblock.

According to another exemplary embodiment of the claimed invention, a bi-directional systolic array architecture interpolative prediction unit being coupled to a plurality of N columns of a reference picture and to a plurality of M columns of an inverse discrete cosine transform residual signal is disclosed. The interpolative prediction unit is for generating pixel data corresponding to a macroblock in motion estimation and compensation, and comprises a first interpolation unit being coupled to a first column and an adjacent second column of the N columns of the first reference picture for outputting a first interpolated pixel value according to pixel values of the first column and the adjacent second column of the first reference picture; a second interpolation unit being coupled to a first column and an adjacent second column of the N columns of the second reference picture for outputting a second interpolated pixel value according to pixel values of the first column and the adjacent second column of the second reference picture; a first adder coupled to the first interpolation unit and the second interpolation unit for adding the first interpolated pixel value and the second interpolated pixel value to thereby form an intermediate signal; and a second adder being coupled to the first adder and a first column of the inverse discrete cosine transform residual signal for adding the intermediate signal and the first column of the inverse discrete cosine transform residual signal to thereby generate video data corresponding to a first column of the macroblock.

According to another exemplary embodiment of the claimed invention, an interpolative prediction unit combining the above single direction and bi-directional motion compensation while utilizing the same hardware is disclosed. The interpolative prediction unit is coupled to a plurality of N columns of a reference picture and to a plurality of M columns of an inverse discrete cosine transform residual signal. The interpolative prediction unit is for generating pixel data corresponding to a macroblock in motion estimation and compensation, and comprises a first interpolation unit being coupled to a first column and an adjacent second column of the N columns of the first reference picture for outputting a first interpolated pixel value according to pixel values of the first column and the adjacent second column of the first reference picture; a second interpolation unit being coupled to (1) a first column and an adjacent second column of the N columns of the second reference picture for outputting a second interpolated pixel value according to pixel values of the first column and the adjacent second column of the second reference picture when bidirectional, and (2) 5^{th} and 6^{th} column of the N columns of the first reference picture for outputting a second interpolated pixel value according to pixel values of the 5th column and the adjacent 6th column of the first reference picture when single direction; a first multiplexer for selectively outputting a first column of the inverse discrete cosine transform residual signal when the interpolative prediction unit is generating pixel data corresponding to a macroblock in single direction motion estimation and compensation; and for outputting the second interpolated pixel, future pixel, when the interpolative prediction unit is generating pixel data corresponding to a macroblock in bi-direction motion estimation and compensation; a first adder coupled to the first multiplexer for adding the output of the first multiplexer with the first interpolated pixel value to thereby form a first output signal;A divider couple to the first adder for dividng the sum of past pixel and feture pixel by 2. a second multiplexer coupled to the first interpolation unit and the first adder for selectively outputting the second interpolated pixel when the interpolative prediction unit is generating pixel data corresponding to a macroblock in single direction motion estimation and compensation; and for outputting the first output signal when the interpolative prediction unit is generating pixel data corresponding to a macroblock in bi-direction motion estimation and compensation; a third multiplexer for selectively outputting a 5th column of the inverse discrete cosine transform residual signal when the interpolative prediction unit is generating pixel data corresponding to a macroblock in single direction motion estimation and compensation; and for outputting a first or 5 th column respective to first or 5^{th} column reference frame input, of the inverse discrete cosine transform residual signal when the interpolative prediction unit is generating pixel data corresponding to a macroblock in bi-direction motion estimation and compensation; and a second adder being coupled to the second multiplexer and the third multiplexer for adding the output of the second multiplexer and the output of the third multiplexer to thereby generate a second output signal, which is 5^{th} pixel when single direction motion compensation and is first or 5^{th} pixel when bi direction motion compensation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a typical single direction motion compensation process according to the related art.

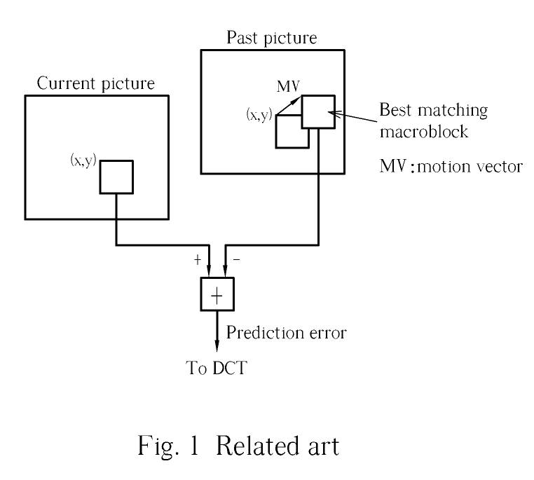

FIG. 2 shows a typical bi-directional motion compensation process according to the related art.

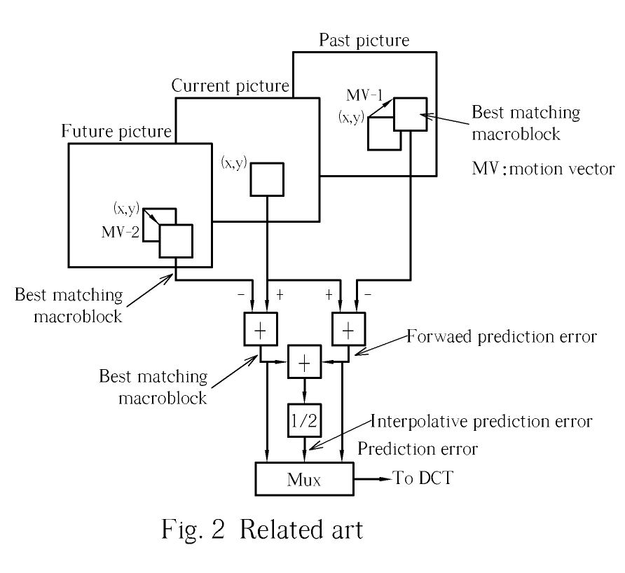

FIG. 3 shows typical equations for the various half pixel interpolation positions encountered in MPEG-2 according to the related art.

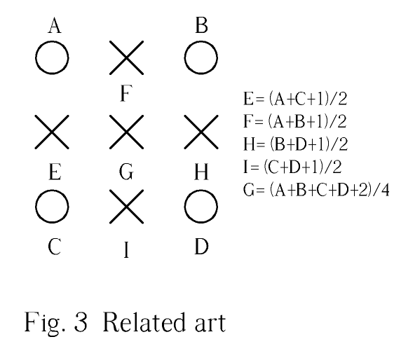

FIG. 4 shows a first typical interpolative prediction unit according to the related art.

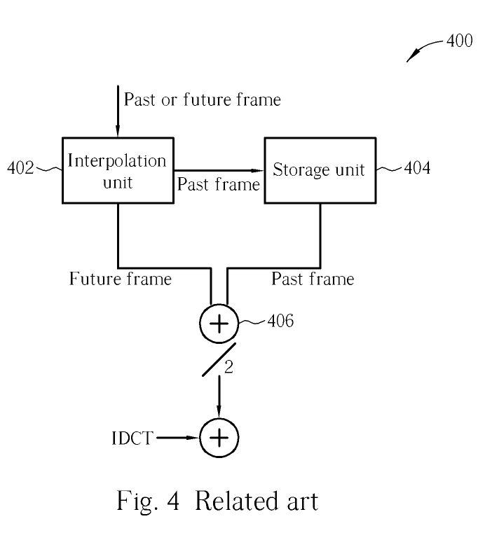

FIG. 5 shows a second typical interpolative prediction unit 500 according to the related art.

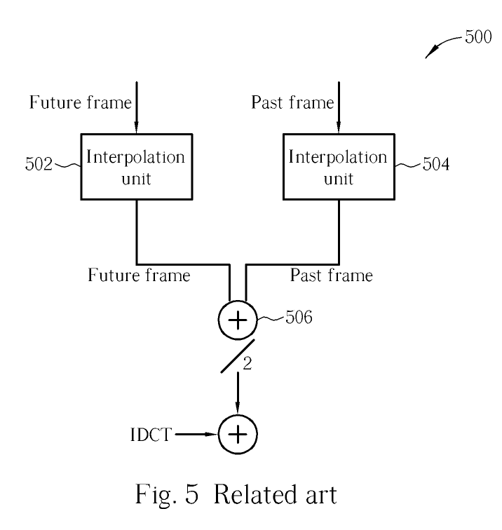

FIG. 6 shows an overall block diagram of an interpolative prediction unit, a new resource-share architecture, according to an exemplary embodiment of the present invention.

FIG. 7 shows a systolic array for implementing the interpolation prediction module of FIG. 6 according to an exemplary embodiment of the present invention.

FIG. 8 shows a first interpolative prediction unit according to a first exemplary embodiment of the present invention.

FIG. 9 shows a second interpolative prediction unit according to a second exemplary embodiment of the present invention.

FIG. 10 shows a third interpolative prediction unit according to a third exemplary embodiment of the present invention.

### DETAILED DESCRIPTION

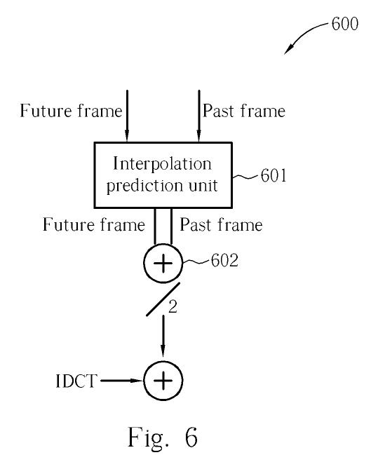

FIG. 6 shows an overall block diagram of an interpolative prediction module 600 having simplified hardware reusability according to an exemplary embodiment of the present invention. As shown in FIG. 6, the interpolative prediction module 600 includes an interpolation prediction unit 602 and an adder and divider 604. The interpolative prediction unit 602 is coupled to at least one reference picture (e.g., the future frame and the past frame), The result is divided by two by the adder and divider 604 to account for the addition of two frames. Then added with idct residual data. The interpolative prediction unit 602 is for generating pixel data corresponding to a macroblock in motion estimation and compensation operations according to the reference picture(s) and the inverse discrete cosine transform residual signal (IDCT). According to this embodiment of the present invention, video data corresponding to a motion prediction operation is generated in a single stage of operation while requiring only a single interpolative prediction unit 602.

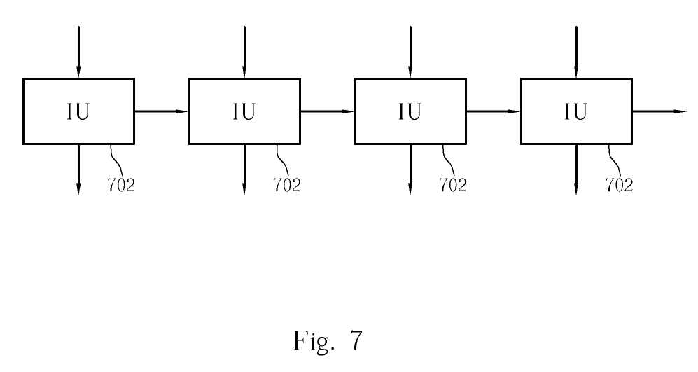

FIG. 7 shows a systolic array 700 for implementing the interpolation prediction unit 602 of FIG. 6 according to an exemplary embodiment of the present invention. As shown in FIG. 7, the interpolation prediction unit 602 includes at least one interpolation unit (IU) 702. If a plurality of interpolation units 702 are included, the interpolation units 702 are organized in a systolic array 700. By using the systolic array 700, the interpolation operation of the interpolation prediction module 602 is broken up into many small operations and can be efficiently implemented according to different requirements. For example, if operation cycles (i.e., operation time) is of primary importance, a higher number of interpolation units 702 can be included in the systolic array 700. Likewise, if reduced hardware is of primary concern, a single (or lower number of) interpolation unit 702 can be included in the systolic array 700. Utilizing the systolic array 700 also allows and easy and regular design. That is, each of the interpolation units 702 can be connected in a similar way having the same pattern. In this way, hardware organization is simplified and process unit re-arranging is also simplified.

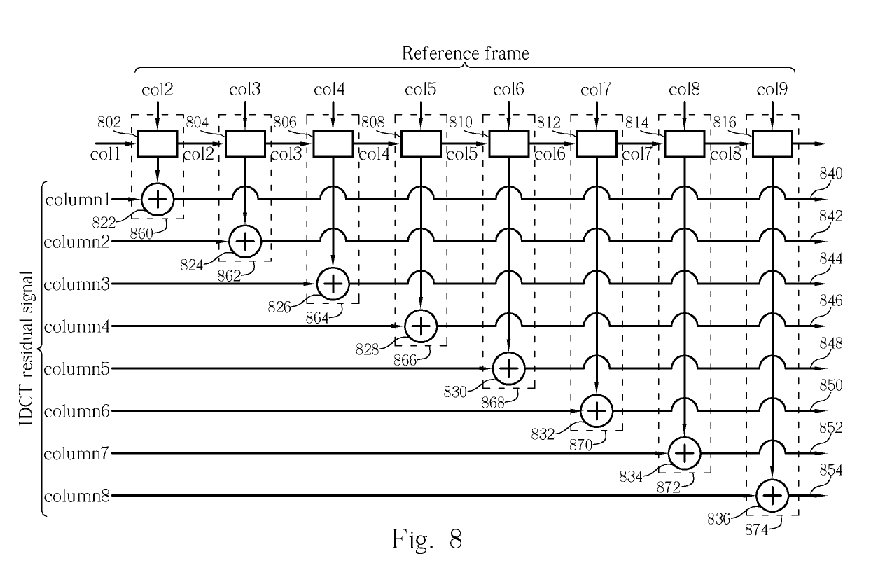

FIG. 8 shows a first interpolative prediction unit 800 according to a first exemplary embodiment of the present invention. For example, the interpolative prediction unit 800 shown in FIG. 8 can be utilized for generating pixel data corresponding to a macroblock in motion estimation and compensation for single direction prediction frames in motion picture experts group MPEG-2 video operations. As shown in FIG. 8, the interpolative prediction unit 800 is coupled to a plurality of N columns of a reference picture and to a plurality of M columns of an inverse discrete cosine transform residual IDCT signal. The reference frame can either be a past frame or a future frame. The interpolative prediction unit 800 generates pixel data corresponding to a macroblock in motion estimation and compensation and includes a plurality of interpolation units and adders organized as a systolic array. In this example, the interpolative prediction unit 800 includes a plurality of eight interpolation units 802 to 816 and eight corresponding adders 822 to 836. Each of the interpolation units 802 to 816 is grouped with a corresponding adder 822 to 836 to thereby form a plurality of interpolation modules 860 to 874. However, the number eight is for example only and other numbers of interpolation modules can also be utilized according to the present invention.

Each interpolation module 860 to 874 includes an interpolation unit being coupled to a particular column and a previous (adjacent) column of the N columns of the reference picture for outputting a corresponding interpolated pixel value according to pixel values of the particular column and the previous column. Also included is a corresponding adder being coupled to the interpolation unit and a corresponding particular column of the inverse discrete cosine transform residual signal for adding the interpolated pixel value outputted by the interpolation unit of the interpolation module and the corresponding particular column of the inverse discrete cosine transform residual signal to thereby generate video data corresponding to a particular column of the macroblock.

For example, a first interpolation module 860 includes a first interpolation unit 802 coupled to a first column coil and an adjacent second column col2 of the N columns of the reference picture. The first interpolation unit 802 outputs an interpolated pixel value according to pixel values of the first column coil and the adjacent second column col2 to a corresponding first adder 822. The first adder 822 is further coupled a first column column1 of the inverse discrete cosine transform residual IDCT signal for adding the interpolated pixel value outputted by the first interpolation module 802 and the first column column1 of the inverse discrete cosine transform residual IDCT signal to thereby generate video data 840 corresponding to a first column of the macroblock in the motion estimation and compensation process.

Similarly, a second interpolation module 862 includes a second interpolation unit 804 coupled to col3 and an adjacent col2 of the N columns of the reference picture. The second interpolation unit 804 outputs an interpolated pixel value according to pixel values of col3 and the adjacent col2 to a corresponding second adder 824. The second adder 824 is further coupled to column2 of the inverse discrete cosine transform residual IDCT signal for adding the interpolated pixel value outputted by the second interpolation module 804 and coolmn1 of the inverse discrete cosine transform residual IDCT signal to thereby generate video data 842 corresponding to a second column of the macroblock in the motion estimation and compensation process.

The plurality of interpolation modules 860 to 874 are each organized similarly to the above description of the first and second interpolation modules 860, 862. In this way, the interpolation units 802 to 816 are organized as a systolic array, where each interpolation module being coupled to a different particular column and a previous column of the N columns of the reference picture.

In this example, the macroblock has eight columns and the number of columns N of the reference picture is equal to nine because the resolution is half pixel. In other words, the pixel values of the first column and the adjacent second column correspond to half pixel values. For this reason, if the total number of interpolation units 802 to 816 used in a situation where the macroblock has eight columns is less than eight, an output of a last interpolation unit can be input into a first interpolation unit for a second round of calculations. That is, the systolic array can actually be implemented using a single (or more than one up to the number of columns of the macroblock) interpolation unit. In general, when the macroblock has P columns and the number of columns N of the reference picture is equal to P+1, and the total number of interpolation units 802 to 816 is less than P, the output of a last interpolation unit is input into a first interpolation unit for a another round of calculations. In these embodiments, multiplexers can be coupled to the interpolation unit(s) for controlling which particular column and previous column of the N columns of the reference picture is coupled to each interpolation unit during each round of calculations.

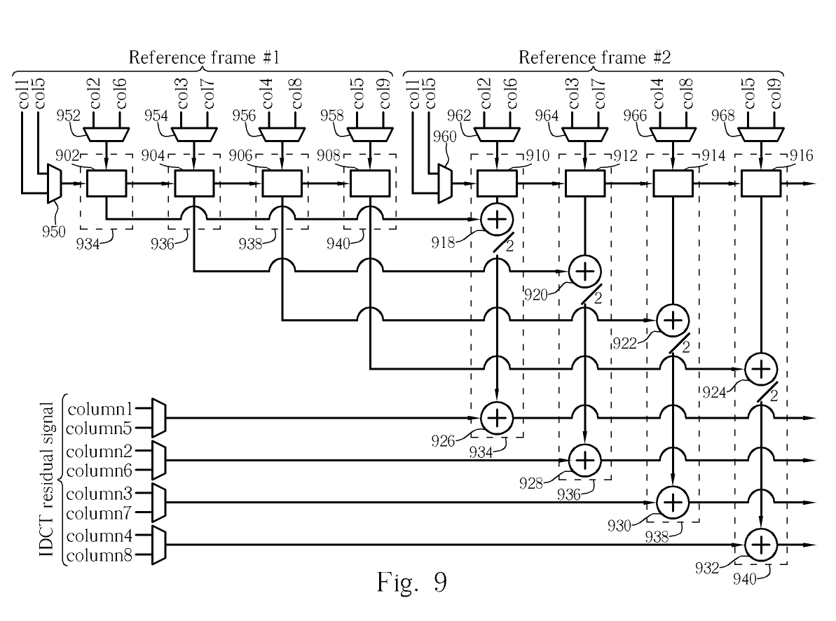

FIG. 9 shows a second interpolative prediction unit 900 according to a second exemplary embodiment of the present invention. For example, the interpolative prediction unit 900 shown in FIG. 9 can be utilized for generating pixel data corresponding to a macroblock in motion estimation and compensation for bi-direction prediction frames in motion picture experts group MPEG-2 video operations. As shown in FIG. 9, the interpolative prediction unit 900 is coupled to a plurality of N columns of a first reference picture, to a plurality of N columns of a second reference picture, and to a plurality of M columns of an inverse discrete cosine transform residual IDCT signal. The interpolative prediction unit 900 generates pixel data corresponding to a macroblock in motion estimation and compensation and includes a plurality of pairs of interpolation units and adders organized as a systolic array. In this example, the interpolation prediction unit 900 includes a plurality of four pairs of interpolation units (902, 910), (904, 912), (906, 914), (908, 916) and four pairs of corresponding adders (918, 926), (920, 928), (922, 930), (924, 932). Each pair of interpolation units (902, 910), (904, 912), (906, 914), (908, 916) is grouped with a corresponding pair of adders (918, 926), (920, 928), (922, 930), (924, 932) to thereby form a plurality of interpolation modules 934, 936, 938, 940. However, the number four is for example only and other numbers of interpolation modules can also be utilized according to the present invention.

Each interpolation module 934, 936, 938, 940 includes a first interpolation unit being coupled to a particular column and an adjacent previous (adjacent) column of the N columns of the first reference picture for outputting a first interpolated pixel value according to pixel values of the first column and the adjacent second column of the first reference picture. A second interpolation unit is coupled to the particular column and the previous (adjacent) column of the N columns of the second reference picture for outputting a second interpolated pixel value according to pixel values of the first column and the adjacent second column of the second reference picture. A first adder is coupled to the first interpolation unit and the second interpolation unit for adding the first interpolated pixel value and the second interpolated pixel value to thereby form an intermediate signal. Finally, a second adder is coupled to the first adder and a first column of the inverse discrete cosine transform residual signal for adding the intermediate signal and a particular column of the inverse discrete cosine transform residual signal to thereby generate video data corresponding to a first column of the macroblock.

For example, a first interpolation module 934 includes a first interpolation unit 902 being coupled to a first column coil and an adjacent second column col2 of the N columns of the first reference picture for outputting a first interpolated pixel value according to pixel values of the first column coil and the adjacent second column col2 of the first reference picture. A second interpolation unit 910 is coupled to a first column coil and an adjacent second column col2 of the N columns of the second reference picture for outputting a second interpolated pixel value according to pixel values of the first column and the adjacent second column of the second reference picture. A first adder 918 is coupled to the first interpolation unit 902 and the second interpolation unit 910 for adding the first interpolated pixel value and the second interpolated pixel value to thereby form an intermediate signal. Finally, a second adder 926 is coupled to the first adder 918 and a first column coolmn1 of the inverse discrete cosine transform residual IDCT signal for adding the intermediate signal and the first column column1 of the inverse discrete cosine transform residual IDCT signal to thereby generate video data corresponding to a first column of the macroblock.

Similarly, a second interpolation module 936 includes a first interpolation unit 904 being coupled to a first column col2 and an adjacent second column col3 of the N columns of the first reference picture for outputting a first interpolated pixel value according to pixel values of the first column col2 and the adjacent second column col3 of the first reference picture. A second interpolation unit 912 is coupled to a first column col2 and an adjacent second column col3 of the N columns of the second reference picture for outputting a second interpolated pixel value according to pixel values of the first column col3 and the adjacent second column col2 of the second reference picture. A first adder 920 is coupled to the first interpolation unit 904 and the second interpolation unit 912 for adding the first interpolated pixel value and the second interpolated pixel value to thereby form an intermediate signal. Finally, a second adder 928 is coupled to the first adder 920 and a second column column2 of the inverse discrete cosine transform residual IDCT signal for adding the intermediate signal and the second column column2 of the inverse discrete cosine transform residual IDCT signal to thereby generate video data corresponding to a second column of the macroblock.

The plurality of interpolation modules 934, 936, 938, 940 are each organized similarly to the above description of the first and second interpolation modules 936, 936. In this way, the pairs of interpolation units (902, 910), (904, 912), (906, 914), (908, 916) are organized as a systolic array, where each interpolation module 934, 936, 938, 940 being coupled to a different particular column and a previous column of the N columns of the reference picture.

In this example, the macroblock has 8 columns and the number of columns N of the reference picture is equal to 9 because the resolution is half pixel. In other words, the pixel values of the first column and the adjacent second column correspond to half pixel values. Therefore, because the total number of pairs of interpolation units 802 to 816 is less than 8, an output of a last interpolation unit can be input into a first interpolation unit for a second round of calculations. That is, the systolic array can actually be implemented using a single (or more than one up to the number of columns of the macroblock) interpolation unit.

In order to control which particular column and previous column of the N columns of the reference picture is coupled to each interpolation unit during each round of calculations, the interpolative prediction modules can further include a plurality of multiplexers 952, 954, 956, 958, 960, 962, 964, 966, 968. Each multiplexer 952, 954, 956, 958, 960, 962, 964, 966, 968 is coupled to an interpolation unit 902, 910, 904, 912, 906, 914, 908, 916 for selecting a particular column and previous column of the N columns of the reference picture.

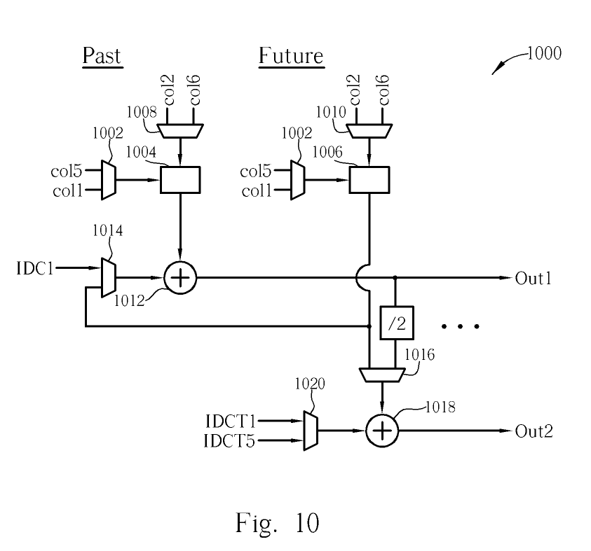

FIG. 10 shows a third interpolative prediction unit 1000 according to a third exemplary embodiment of the present invention. For example, the interpolative prediction unit 1000 shown in FIG. 10 can be utilized for generating pixel data corresponding to a macroblock in motion estimation and compensation for single direction or bi-direction prediction frames. That is, the third embodiment shown in FIG. 10 is actually a combination of the first and second embodiments of FIG. 8 and FIG. 9. Multiplexers are utilized to select the various inverse discrete cosine transform residual IDCT signal columns and the columns of the reference pictures, in addition to the paths between the interpolation modules. For example, because a minimum of two interpolation modules are required for bi-direction prediction frames, these two interpolation units can be configured as a systolic array for single bi-direction prediction frames to thereby reduce the number of operation cycles.

As shown in FIG. 10, a first interpolation unit 1004 is coupled to a first column col1 or col5 and an adjacent second column col2 or col6 of the N columns of the first reference picture for outputting a first interpolated pixel value according to pixel values of the first column col1 or col5 and the adjacent second column col2 or col6 of the first reference picture. A second interpolation unit 1006 is coupled to a first column col1 or col5 and an adjacent second column col2 or col6 of the N columns of the second reference picture for outputting a second interpolated pixel value according to pixel values of the first column col1 or col5 and the adjacent second column col2 or col6 of the second reference picture. Multiplexers 1002, 1008, 1010 are utilized in order to select which columns are input to the first and second interpolation units 1004, 1006.

Multiplexer 1014 selectively outputs a first column IDCT1 of the inverse discrete cosine transform residual signal when the interpolative prediction unit 1000 is generating pixel data corresponding to a macroblock in single direction motion estimation and compensation, and outputs the second interpolated pixel when the interpolative prediction unit 1000 is generating pixel data corresponding to a macroblock in bi-direction motion estimation and compensation. A first adder 1012 is coupled to the multiplexer 1014 for adding the output of the multiplexer 1014 with the first interpolated pixel value to thereby form a first output signal Out1.

Multiplexer 1016 is coupled to the first interpolation unit 1004 and the first adder 1012 for selectively outputting the second interpolated pixel when the interpolative prediction unit 1000 is generating pixel data corresponding to a macroblock in single direction motion estimation and compensation, and is for outputting the first output signal when the interpolative prediction unit 1000 is generating pixel data corresponding to a macroblock in bi-direction motion estimation and compensation. Next, multiplexer 1020 is for selectively outputting a fifth column IDCT5 of the inverse discrete cosine transform residual signal when the interpolative prediction unit is generating pixel data corresponding to a macroblock in single direction motion estimation and compensation, and is for outputting a first column IDCT1 of the inverse discrete cosine transform residual signal when the interpolative prediction unit 1000 is generating pixel data corresponding to a macroblock in bi-direction motion estimation and compensation. Finally, a second adder 1018 is coupled to the multiplexer 1016 and the multiplexer 1020 for adding the output of the multiplexer 1016 and the output of the multiplexer 1020 to thereby generate a second output signal Out2.

It should also be noted that the structure of the interpolation prediction unit 1000 can also be enhanced by providing a plurality of pairs of interpolation modules, where each pair of interpolation modules includes the same components as shown in FIG. 10 but having the respective columns and columns shifted such that the interpolation modules are coupled in a systolic array. That is, each interpolation module of each pair being coupled to a different particular column and a previous column of the N columns of the first reference picture and second reference picture, respectively.

According to the present invention, a systolic array of interpolation units is utilized to for performing interpolative prediction and generating pixel data corresponding to a macroblock in motion estimation and compensation. The interpolative prediction unit is coupled to a plurality of N columns of a reference picture and to a plurality of M columns of an inverse discrete cosine transform residual signal. An interpolation unit is coupled to a first column and an adjacent second column of the N columns of the reference picture for outputting an interpolated pixel value according to pixel values of the first column and the adjacent second column; and an adder is coupled to the interpolation unit and a first column of the inverse discrete cosine transform residual signal for adding the interpolated pixel value outputted by the interpolation module and the first column of the inverse discrete cosine transform residual signal to thereby generate video data corresponding to a first column of the macroblock. In this way, hardware requirements of the interpolation prediction unit is reduced and a number of cycles of operation can be controlled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interpolative prediction unit being coupled to a plurality of N columns of a reference picture and to a plurality of M columns of an inverse discrete cosine transform residual signal, the interpolative prediction unit for generating pixel data corresponding to a macroblock in motion estimation and compensation, and comprising:
an interpolation unit being coupled to a first column and an adjacent second column of the N columns of the reference picture for outputting an interpolated pixel value according to pixel values of the first column and the adjacent second column; and
an adder being coupled to the interpolation unit and a first column of the inverse discrete cosine transform residual signal for adding the interpolated pixel value outputted by the interpolation module and the first column of the inverse discrete cosine transform residual signal to thereby generate video data corresponding to a first column of the macroblock.

2. The interpolative prediction unit of claim 1, further comprising a plurality of interpolation modules, each interpolation module including:
an interpolation unit being coupled to a particular column and a previous column of the N columns of the reference picture for outputting a corresponding interpolated pixel value according to pixel values of the particular column and the previous column; and
a corresponding adder being coupled to the interpolation unit and a corresponding particular column of the inverse discrete cosine transform residual signal for adding the interpolated pixel value outputted by the interpolation unit of the interpolation module and the corresponding particular column of the inverse discrete cosine transform residual signal to thereby generate video data corresponding to a particular column of the macroblock.

3. The interpolative prediction unit of claim 2, wherein the plurality of interpolation modules are organized as a systolic array, each interpolation module being coupled to a different particular column and a previous column of the N columns of the reference picture.

4. The interpolative prediction unit of claim 2, wherein the macroblock has P columns and the number of columns N of the reference picture is equal to P+1.

5. The interpolative prediction unit of claim 4, wherein a total number of interpolation units is less than P and an output of a last interpolation unit is input into a first interpolation unit for a second round of calculations.

6. The interpolative prediction unit of claim 5, further comprising a plurality of multiplexers, each multiplexer being coupled to an interpolation unit for controlling which particular column and previous column of the N columns of the reference picture is coupled to each interpolation unit during each round of calculations.

7. The interpolative prediction unit of claim 1, wherein the pixel values of the first column and the adjacent second column correspond to half pixel values.

8. The interpolative prediction unit of claim 1, being for generating pixel data corresponding to a macroblock in motion estimation and compensation in motion picture experts group MPEG-like video operations.

9. The interpolative prediction unit of claim 1, wherein the reference picture corresponds to a previous frame or future frame and the interpolative prediction unit is for generating pixel data corresponding to a macroblock in motion estimation and compensation for single direction prediction frames.

10. An interpolative prediction unit being coupled to a plurality of N columns of a first reference picture, to a plurality of N columns of a second reference picture, and to a plurality of M columns of an inverse discrete cosine transform residual signal, the interpolative prediction unit for generating pixel data corresponding to a macroblock in motion estimation and compensation, and comprising:
a first interpolation unit being coupled to a first column and an adjacent second column of the N columns of the first reference picture for outputting a first interpolated pixel value according to pixel values of the first column and the adjacent second column of the first reference picture;
a second interpolation unit being coupled to a first column and an adjacent second column of the N columns of the second reference picture for outputting a second interpolated pixel value according to pixel values of the first column and the adjacent second column of the second reference picture;
a first adder coupled to the first interpolation unit and the second interpolation unit for adding the first interpolated pixel value and the second interpolated pixel value to thereby form an intermediate signal; and
a second adder being coupled to the first adder and a first column of the inverse discrete cosine transform residual signal for adding the intermediate signal and the first column of the inverse discrete cosine transform residual signal to thereby generate video data corresponding to a first column of the macroblock.

11. The interpolative prediction unit of claim 10, further comprising a plurality of pairs of interpolation modules, each pair of interpolation modules including:
an interpolation unit being coupled to a particular column and a previous column of the N columns of the first reference picture for outputting a corresponding first interpolated pixel value according to pixel values of the particular column and the previous column of the first reference picture;
an other interpolation unit being coupled to a particular column and a previous column of the N columns of the second reference picture for outputting a corresponding second interpolated pixel value according to pixel values of the first column and the adjacent second column of the second reference picture;
a third adder coupled to the interpolation unit and the other interpolation unit of the pair for adding the corresponding first interpolated pixel value and the corresponding second interpolated pixel value to thereby form a corresponding intermediate signal; and
a second adder being coupled to the third adder and a particular column of the inverse discrete cosine transform residual signal for adding the corresponding intermediate signal and the particular column of the inverse discrete cosine transform residual signal to thereby generate video data corresponding to a particular column of the macroblock.

12. The interpolative prediction unit of claim 11, wherein the plurality of pairs of interpolation modules are organized as a systolic array, each interpolation module of each pair being coupled to a different particular column and corresponding previous column of the N columns of the first reference picture and second reference picture, respectively.

13. The interpolative prediction unit of claim 11, wherein the macroblock has P columns and the number of columns N of the first and second reference pictures is equal to P+1.

14. The interpolative prediction unit of claim 13, wherein a number of interpolation units is less than P and an output of a last interpolation unit is input into a first interpolation unit for a second round of calculations.

15. The interpolative prediction unit of claim 14, further comprising a plurality of multiplexers, each multiplexer being coupled to an interpolation unit for controlling which particular column and previous column of the N columns of the reference picture is coupled to each interpolation unit during each round of calculations.

16. The interpolative prediction unit of claim 10, wherein the pixel values of the first column and the adjacent second column correspond to half pixel values.

17. The interpolative prediction unit of claim 10, being for generating pixel data corresponding to a macroblock in motion estimation and compensation in motion picture experts group MPEG-like video operations.

18. The interpolative prediction unit of claim 10, wherein the first reference picture corresponds to a previous frame, the second reference picture corresponds to a future frame, and the interpolative prediction unit is for generating pixel data corresponding to a macroblock in motion estimation and compensation for bidirectional prediction frames.

19. An interpolative prediction unit being coupled to a plurality of N columns of a first reference picture, to a plurality of N columns of a second reference picture, and to a plurality of M columns of an inverse discrete cosine transform residual signal, the interpolative prediction unit for generating pixel data corresponding to a macroblock in motion estimation and compensation, and comprising:
a first interpolation unit being coupled to a first column and an adjacent second column of the N columns of the first reference picture for outputting a first interpolated pixel value according to pixel values of the first column and the adjacent second column of the first reference picture;
a second interpolation unit being coupled to a first column and an adjacent second column of the N columns of the second reference picture for outputting a second interpolated pixel value according to pixel values of the first column and the adjacent second column of the second reference picture when bidirectional, and coupled to a 5th column and an adjacent second column of the N columns of the first reference picture for outputting a second interpolated pixel value according to pixel values of the first column and the adjacent second column of the first reference picture when single;
a first multiplexer for selectively outputting a first column of the inverse discrete cosine transform residual signal when the interpolative prediction unit is generating pixel data corresponding to a macroblock in single direction motion estimation and compensation; and for outputting the second interpolated pixel when the interpolative prediction unit is generating pixel data corresponding to a macroblock in bi-direction motion estimation and compensation;
a first adder coupled to the first multiplexer for adding the output of the first multiplexer with the first interpolated pixel value to thereby form a first output signal;
a second multiplexer coupled to the first interpolation unit and the first adder for selectively outputting the second interpolated pixel when the interpolative prediction unit is generating pixel data corresponding to a macroblock in single direction motion estimation and compensation; and for outputting the first output signal when the interpolative prediction unit is generating pixel data corresponding to a macroblock in bi-direction motion estimation and compensation;
a third multiplexer for selectively outputting a particular column of the inverse discrete cosine transform residual signal when the interpolative prediction unit is generating pixel data corresponding to a macroblock in single direction motion estimation and compensation; and for outputting a first column of the inverse discrete cosine transform residual signal when the interpolative prediction unit is generating pixel data corresponding to a macroblock in bi-direction motion estimation and compensation; and
a second adder being coupled to the second multiplexer and the third multiplexer for adding the output of the second multiplexer and the output of the third multiplexer to thereby generate a second output signal.

20. The interpolative prediction unit of claim 19, further comprising a plurality of pairs of interpolation modules, each pair of interpolation modules including:
an interpolation unit being coupled to a particular column and a previous column of the N columns of the first reference picture for outputting a corresponding first interpolated pixel value according to pixel values of the particular column and the previous column of the first reference picture;
another interpolation unit being coupled to a particular column and a previous column of the N columns of the second reference picture for outputting a corresponding second interpolated pixel value according to pixel values of the first column and the adjacent second column of the second reference picture when bidirectional and coupled to a particular column and a previous column of the N columns of the first reference picture for outputting a corresponding second interpolated pixel value according to pixel values of the particular column and the adjacent second column of the first reference picture when single;
a fourth multiplexer for selectively outputting a second particular column of the inverse discrete cosine transform residual signal when the interpolative prediction unit is generating pixel data corresponding to a macroblock in single direction motion estimation and compensation; and for outputting the corresponding second interpolated pixel when the interpolative prediction unit is generating pixel data corresponding to a macroblock in bi-direction motion estimation and compensation;
a third adder coupled to the fourth multiplexer for adding the output of the fourth multiplexer with the corresponding first interpolated pixel value to thereby form an output signal;
a fifth multiplexer coupled to the interpolation unit and the third adder for selectively for outputting the corresponding second interpolated pixel value when the interpolative prediction unit is generating pixel data corresponding to a macroblock in single direction motion estimation and compensation; and for outputting the output signal when the interpolative prediction unit is generating pixel data corresponding to a macroblock in bi-direction motion estimation and compensation;
a sixth multiplexer for selectively outputting a third particular column of the inverse discrete cosine transform residual signal when the interpolative prediction unit is generating pixel data corresponding to a macroblock in single direction motion estimation and compensation; and for outputting a previous column of the inverse discrete cosine transform residual signal when the interpolative prediction unit is generating pixel data corresponding to a macroblock in bi-direction motion estimation and compensation; and
a fourth adder being coupled to the fifth multiplexer and the sixth multiplexer for adding the output of the fifth multiplexer and the output of the sixth multiplexer to thereby generate another output signal.

21. The interpolative prediction unit of claim 20, wherein the plurality of pairs of interpolation modules are organized as a systolic array, each interpolation module of each pair being coupled to a different particular column and a previous column of the N columns of the first reference picture and second reference picture, respectively.

22. The interpolative prediction unit of claim 20, wherein the macroblock has P columns and the number of columns N of the reference picture is equal to P+1.

23. The interpolative prediction unit of claim 22, wherein a number of interpolation units is less than P and an output of a last interpolation unit is input into a first interpolation unit for a second round of calculations.

24. The interpolative prediction unit of claim 23, further comprising a plurality of multiplexers, each multiplexer being coupled to an interpolation unit for controlling which particular column and previous column of the N columns of the reference picture is coupled to each interpolation unit during each round of calculations.

25. The interpolative prediction unit of claim 19, wherein the pixel values of the first column and the adjacent second column correspond to half pixel values.

26. The interpolative prediction unit of claim 19, being for generating pixel data corresponding to a macroblock in motion estimation and compensation in motion picture experts group MPEG-like video operations.

27. The interpolative prediction unit of claim 19, being for generating pixel data corresponding to a macroblock in motion estimation and compensation for single direction or bi-direction motion prediction frames.
